(19) United States
(12) Patent Application Publication
(10) Pub. No.: US 2012/0143906 A1
(43) Pub. Date: Jun. 7, 2012

(54) Method of Accessing and Executing Digital Media

(75) Inventors: Jeffrey Sibbold, Ann Arbor, MI (US); Bryan Kelly, Plymouth, MI (US)

(73) Assignee: Twisted Castle, LLC, Ann Arbor, MI (US)

(21) Appl. No.: 13/280,689

(22) Filed: Oct. 25, 2011

Related U.S. Application Data
(60) Provisional application No. 61/419,003, filed on Dec. 2, 2010.

(51) Int. Cl. G06F 17/30; G06F 15/16

(52) U.S. Cl. 707/769; 709/217; 707/E17.014

(57) ABSTRACT

A method of accessing and executing digital media that includes receiving preview media files, executing one of the preview media files upon receiving a communication event, and electronically communicating a profile of the executed preview media file and a purchase solicitation. The method includes receiving a whole media file corresponding to the executed preview media file, upon receiving a purchase request.

### CROSS REFERENCE TO RELATED APPLICATIONS

This U.S. patent application claims priority under 35 U.S.C. §119(e) to U.S. Provisional Application 61/419,003, filed on Dec. 2, 2010, which is hereby incorporated by reference in its entirety.

### TECHNICAL FIELD

This disclosure relates to methods of accessing and executing digital media on electronic devices.

### BACKGROUND

Digital music and other media has typically been downloadable from a web service to a user's computer or personal digital assistant (PDA) for viewing and playing. Moreover, a user can manually download a ringtone form a web service or local computer and set that ringtone as a default ringtone and/or as the ringtone for calls from certain people.

### SUMMARY

One aspect of the disclosure provides a method of accessing and executing digital media. The method includes receiving preview media files from an external source, storing the received preview media files in a queue of an electronic device, and executing one of the preview media files stored in the queue upon receiving a communication event. The method also includes electronically communicating a profile of the executed preview media file and a purchase solicitation to a user of the electronic device, and upon receiving a purchase request, querying the external source for a whole media file corresponding to the executed preview media file.

Implementations of the disclosure may include one or more of the following features. In some implementations, the method includes querying the external source to receive preview media files. The method may include removing the executed preview media file from the queue after executing the preview media file. Moreover, the method may include receiving at least one additional preview media file from the external source and storing the at least one additional received preview media file in the queue after removing the executed preview media file from the queue. In some examples, the method includes limiting receipt of the preview media files in the queue to a threshold number of preview media files stored in the queue over a time period. One of the received media preview files can be randomly selected from the queue for execution. The method may include receiving additional preview media files from the external source when a number of preview media files in the queue is below a threshold queue number. In some examples, the method includes receiving a number of preview media file equal to a difference between the threshold queue number and a number of preview media files in the queue. The communication event may include at least one of a phone call, a text message, an email, a video call, and a page. Moreover, the queue may comprise memory of the electronic device.

Another aspect of the disclosure provides a media system that includes a file manager that receives preview media files from an external source and stores the received preview media files in a queue of an electronic device. A player executes one of the preview media files stored in the queue upon receiving a communication event. A purchase manager electronically communicates a profile of the executed preview media file and a purchase solicitation to a user of the electronic device. Upon receiving a purchase request, the purchase manager queries the external source for a whole media file corresponding to the executed preview media file.

In some implementations, the file manager queries the external source to receive preview media files. The file manager may remove the executed preview media file from the queue after executing the preview media file. In some examples, the file manager receives at least one additional preview media file from the external source and stores the at least one additional received preview media file in the queue after removing the executed preview media file from the queue. The file manager may limit receipt of the preview media files in the queue to a threshold number of preview media files stored in the queue over a time period. In some implementations, the file manager receives additional preview media files from the external source when a number of preview media files in the queue is below a threshold queue number. Moreover, the file manager may receive a number of preview media file equal to a difference between the threshold queue number and a number of preview media files in the queue. The player may randomly select one of the received media preview files from the queue for execution. The communication event may include at least one of a phone call, a text message, an email, a video call, and a page. The queue may comprise memory of the electronic device.

In yet another aspect, a method of accessing and executing digital media includes receiving a download criteria, broadcasting within an electronic device a change intent corresponding to the download criteria, and in response to the broadcasted change intent, executing a list service on a processor of the electronic device. The list service receives preview media files from an external source according to the download criteria. The method further includes executing a preview media file in response to initiation of a communication event, electronically displaying a profile corresponding to the executed preview media file and a purchase solicitation, and upon receiving a purchase request, receiving a whole media file from the external source corresponding to the executed preview media file.

In some implementations, the method includes displaying a download criteria selector. The download criteria selector may include at least one of a text search box and a list. The method may include receiving a search string in the download criteria selector and displaying a list of download criteria corresponding to the search string. The download criteria can be stored in a storage device of the electronic device. In some examples, the method includes receiving account information and storing the account information in a storage device of the electronic device.

The list service may check connectivity of the electronic device to a network before attempting to receive preview media files. The method may include attempting to receive additional preview media files after termination of the communication event. In some examples, the method includes querying the external source to receive preview media files. The preview media files can be received into a queue. The method may include removing the executed preview media file from the queue after executing the preview media file. Moreover, in some examples, the method includes receiving at least one additional preview media file from the external source and storing the at least one additional received preview media file in the queue after removing the executed preview media file from the queue. Receipt of the preview media files in the queue can be limited to a threshold number of preview media files stored in the queue over a time period. One of the received media preview files randomly selected from the queue for execution. The method may include receiving additional preview media files from the external source when a number of preview media files in the queue is below a threshold queue number.

Moreover, the method may include receiving a number of preview media file equal to a difference between the threshold queue number and a number of preview media files in the queue. The communication event may include at least one of a phone call, a text message, an email, a video call, and a page.

Another aspect provides a method that includes receiving preview media files, executing one of the preview media files upon receiving a communication event, and electronically communicating a profile of the executed preview media file and a purchase solicitation. The method includes receiving a whole media file corresponding to the executed preview media file, upon receiving a purchase request.

Another aspect provides a method that includes receiving preview media files, using one of the preview media files upon receiving a communication event to receive streaming media to an electronic device, electronically communicating a profile of the used preview media file and a purchase solicitation, and upon receiving a purchase request, receiving a whole media file corresponding to the executed preview media file. The whole media file provides access to additional streaming media.

In some implementations, the preview media file provides access to corresponding preview streaming media and the whole media file provides access to full length streaming media. The preview media file may include at least one of account information, access information, a source address, a destination address, and a media selection criteria. In some examples, the method includes electronically displaying the profile of the used preview media file and the purchase solicitation on the electronic device. The method may include receiving the streaming media from an external source. Moreover, the method may include querying an external source to receive preview media files.

The received preview media files may be stored in a queue. In some examples, the method includes removing the used preview media file from the queue after using the preview media file to receive streaming media. The method may include receiving at least one additional preview media file from an external source and storing the at least one additional received preview media file in the queue after removing the used preview media file from the queue. Storage of the preview media files in the queue can be limited to a threshold number of preview media files over a time period. The method may include randomly selecting one of the received media preview files from the queue for usage to receive steaming media. In some examples, the method includes receiving additional preview media files from the external source when a number of preview media files in the queue is below a threshold queue number. Moreover, the method may include receiving a number of preview media file equal to a difference between the threshold queue number and a number of preview media files in the queue. The communication event may include at least one of a phone call, a text message, an email, a video call, and a page.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a media system.

FIG. 2 is a schematic view of an exemplary electronic device displaying a download criteria selector.

FIG. 3 is a schematic view of an exemplary electronic device displaying an artist selector.

FIG. 4 is a schematic view of an exemplary electronic device displaying a genre selector and a preview item selector.

FIG. 5 provides an exemplary state diagram of a media system.

FIG. 6 provides an exemplary arrangement of operations for accessing and executing digital media.

Like reference symbols in the various drawings indicate like elements.

### DETAILED DESCRIPTION

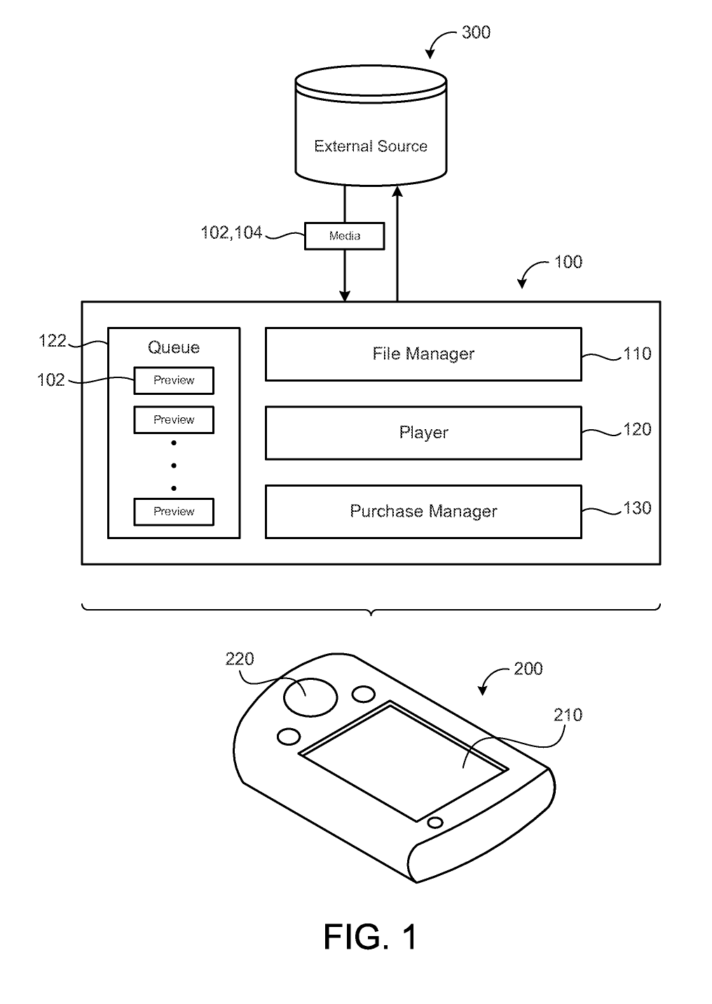

Referring to FIG. 1, in some implementations, a media system 100, executable on an electronic device 200 (e.g., a computing processor), includes a file manager 110, a player 120, and a purchase manager 130. The file manger 110 receives preview media files 102 (e.g., previews of songs or videos, usually 30 seconds in duration) from an external source 300 and stores the received preview media files 102 in a queue 122 (e.g., memory) of the electronic device 200. The preview media files 102 can be stored in one or more formats, including, but not limited to, MPEG-1 or MPEG-2 Audio Layer 3, more commonly referred to as MP3, Advanced Audio Coding File (.aac), Audio Interchange File Format (.aif), Interchange File Format (.iff), Media Playlist File (.m3u), MIDI File (.mid), Real Audio File (.ra), WAVE Audio File (.wav), Windows Media Audio File (.wma), 3GPP2 Multimedia File (0.3g2), 3GPP Multimedia File (0.3gp), Advanced Systems Format File (.asf), Microsoft ASF Redirector File (.asx), Audio Video Interleave File (.avi), Flash Video File (.flv), Apple QuickTime Movie (.mov), MPEG-4 Video File (.mp4), MPEG Video File (.mpg), Real Media File (.rm), Flash Movie (.swf), DVD Video Object File (.vob), and/or Windows Media Video File (.wmv). Other file formats are possible as well, including those for streaming video and other digital media. The media system 100 can access the external source 300 through a local connection (e.g., Ethernet, universal serial bus (USB), etc.) and/or a remote connection (e.g., wireless connection). The media system 100 may access the external source 300 through a local network and/or the Internet (e.g., using Hypertext Transfer Protocol (HTTP), which is a networking protocol for distributed, collaborative, hypermedia information systems). The file manager 110 may query a database of the external source 300 by accessing an application program interface (API) provided on a server of the external source 300. In some examples, the external source 300 is an Internet web service hosted or otherwise provided by a third party. The user may access the external source using account login information to view, play, and download preview media files 102 and/or whole media files 104.

In some examples, the file manager 110 limits receipt of the preview media files 102 to a threshold number (e.g., 5, 10, 20, 33, etc.) of preview media files 102 stored in the queue 122 over a time period (e.g., at any given time or a duration of time). A user of the electronic device 200 may instruct the file manager 110 to receive certain types of preview media files 102. For example, the file manager 110 may restrict receipt of preview media files 102 to those of a particular file type, genre, artist, producer, owner, age, etc. Moreover, the file manager 110 may query the external source 300 for certain preview media files 102 (e.g., as identified by the user or according to a selection criteria). In some examples, the file manager 110 allows the user to specify what kind of media he/she would like to hear/view by choosing a media type or download criteria from an option menu. For example, the user can specify: 1) top tracks; 2) top tracks by a particular artist; 3) all songs by a particular artist; 4) all songs in a particular genre; 5) new songs in a particular genre; or 6) top tracks in a particular genre. The file manager 110 may download the preview media files 102 from the external source 300 in random order (pseudo-random) to the electronic device 200.

The player 120, in some implementations, executes one of the preview media files 102 stored in the queue 122 upon receiving a communication event. The communication event may include a phone call, a text message, an email, a video call, and/or a page received by the electronic device 200. For example, for a phone or mobile phone, the player 120 executes the preview media file 102 as the ringtone upon receiving an incoming call. The preview media file 102 may be about 30 seconds long and played until the phone is answered or played in a repeating loop until the phone is answered or the communication event is terminated. In some examples, the player 120 randomly selects a preview media file 102 from the queue 122 for execution. Moreover, each time the electronic device 200 receives a communication event, a different preview media file 102 (e.g., portion of a music track) may be set for execution (e.g., as the next ringtone).

In some implementations, the preview media file 102 is an address, access or information file for accessing and receiving streaming media (e.g., streaming video) to the electronic device 200. For example, upon initiation of a communication event (such as an incoming call to a cellular phone), the player 120 selects (e.g., randomly) a preview media file 102 from the queue 122 for execution. However, rather than actually playing a digital media file (e.g., as an executable file), the preview media file 102 provides the player 120 with access information to receive streaming media from the external source 300, which is played on the electronic device 200 (e.g., as it is received). The preview media file 102 may include account information, source and destination address information, the selected download criteria, etc. In some examples, the player 120 communicates the preview media file 102 to the external source 300 to receive the streaming media. Once used (e.g. accessed, played, and/or communicated) the preview media file 102 is removed from the queue 122 and the file manager 110 may download or otherwise receive another preview media file 102 into the queue 122.

The purchase manager 130 may electronically communicate a profile of the executed or otherwise used preview media file 102 and a purchase solicitation to the user. For example, the purchase manager 130 can electronically display on a screen 210 and/or announce on a speaker 220 of the electronic device 200 the profile and purchase solicitation for a whole media file 104 corresponding to the preview media file 102. The whole media file 104 may include a full length version of the media accessed or played through the preview media file 102. Moreover, for streaming media, the whole media file 104 may provide access to receiving a full-length streaming of the previewed digital media. If the user decides to purchase the whole media file 104, the purchase manager 130, upon receiving the purchase request, queries the external source 300 for the whole media file 104. The external source 300 providing the whole media file 104 may be different from the external source 300 that provided the preview media files 102. The purchase manager 130 may store account or access information for accessing the external source 300. This information can be encrypted. For example, the purchase manager 130 may store a user name and password for accessing a download site of the external source 300.

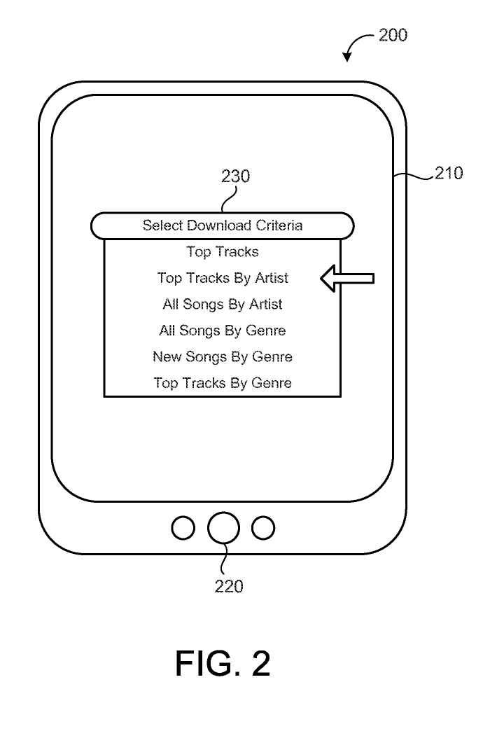

Referring to FIG. 2, in some implementations, when the user executes the media system 100 on the electronic device 200 for the first time, the media system 100 prompts the user to select a download criteria or media type (e.g., via a menu with radio buttons of which they can only select one). In the example shown, the download criteria include 1) top tracks, 2) top tracks by a particular artist, 3) all songs by a particular artist, 4) all songs in a particular genre, 5) new songs in a particular genre, and 6) top tracks in a particular genre; however, other criteria or selection are possible as well. Moreover, in some examples, the user can tailor the download criteria to accommodate different external sources 300. The file manager 110 can display a download criteria selector 230 (e.g., a combo box or list electronically displayed on the screen 210) to allow the user to select a download criteria.

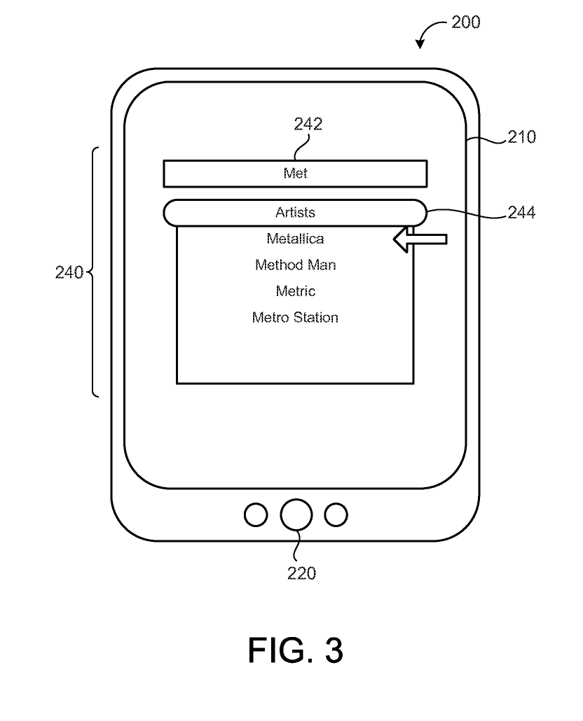

Referring to FIG. 3, in some implementations, upon selecting options 2) top tracks by a particular artist or 3) all songs by a particular artist, the file manager 110 displays an artist selector 240. The artist selector 240 may include a text search box 242 that allows the user to search for an artist by name and/or a search list 244 (e.g., dropdown list or list box) of known artists (e.g., populated by a querying the external source 300 for all artists available in its database). In some examples, a name filter can be executed on the search list 244 based on the characters typed into the text search box 242 to narrow the listing of artists as the user types the artist's name The file manager 110 may query the external source 300 for artists having the exact name and/or similar names entered in the text search box 242. In response to the query, the external source 300 may return a response object that includes artist information. The response object may include extensible markup language (XML), JavaScript object notation (JSON), a relational database object, and/or a type object oriented programming element or data structure. After the user selects an artist, the file manager 110 sends a query to the external source 300 for data on all tracks, all top tracks and/or preview media files 102 corresponding to the selected artist. The query may include structured query language (SQL) using a unique identifier (ID) of the selected artist. After selecting an artist, the file manager 110 may display a button that provides access to the artist selector 240 for changing the selected artist.

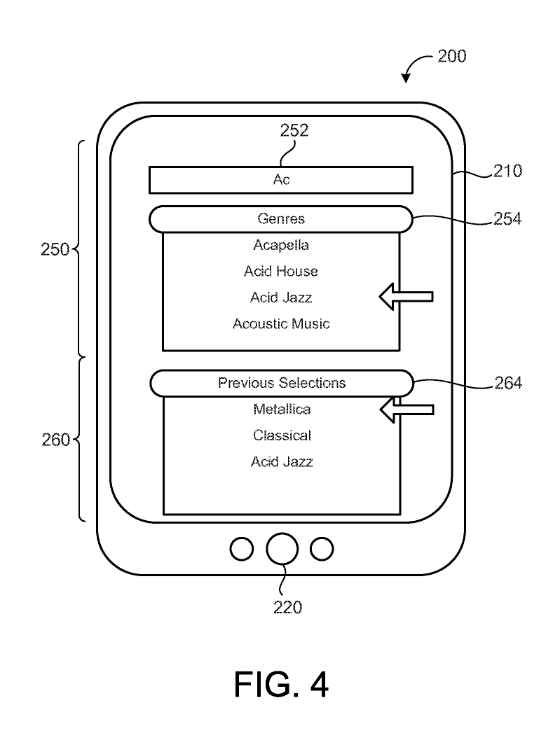

Referring to FIG. 4, after selecting one of options 4) all songs in a particular genre, 5) new songs in a particular genre, or 6) top tracks in a particular genre, the file manger 110 may display a genre selector 250. The genre selector 250 may include a text search box 252 that allows the user to search for a genre by name and/or a search list 254 (e.g., dropdown list or list box) of known genres (e.g., populated by a querying the external source 300 for all genres available in its database). In some examples, a name filter can be executed on the search list 254 based on the characters typed into the text search box 252 to narrow the listing of genres as the user types the genre's name The file manager 110 may query the external source 300 for genres having the exact name and/or similar names entered in the text search box 252. In response to the query, the external source 300 may return a response object that includes genre information. After the user selects a genre, the file manager 110 sends a query to the external source 300 for data on all tracks, all top tracks, new songs, and/or preview media files corresponding to the selected genre. The query may include structured query language (SQL) using a unique identifier (ID) of the selected genre. After selecting a genre, the file manager 110 may display a button that provides access to the genre selector 250 for changing the selected genre.

When switching between download options, previously selected options can be saved (e.g., in memory) and displayed in a previous item selector 260, which can include a dropdown box or list 264. For example, if the user selects Metallica as an artist and then selects a genre of type classical, the user can switch back to Metallica by selecting Metallica in the previous item selector 260, as in the example shown in FIG. 4.

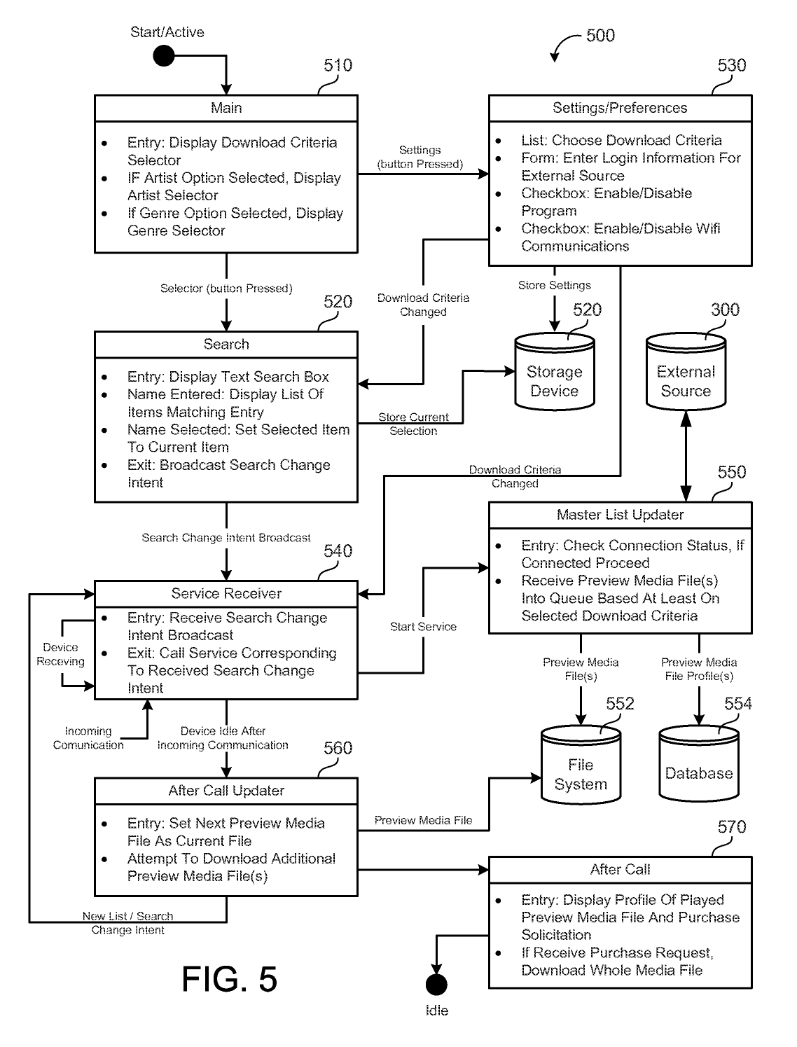

FIG. 5 provides an exemplary state diagram 500 of the media system 100. In the example shown, the media system 100 includes a main module 510 which provides the download criteria selector 230. If the user selects a download criteria based on an artist or a genre, a search module 520 provides the artist selector 240 or the genre selector 250, respectively. Each selector 240, 250 can have a search text box 242, 252 and corresponding search list 244, 254. As the user enters text into the text search box 242, 252, the search module 520 displays in the search list 244, 254 a list of artists or genres matching, stemming from, or similar to the entered text in the text search box 242, 252. The search module 520 can broadcast a search change intent that can be received by other modules of the media system 100 (e.g., a system-wide broadcast).

In some implementations, the main module 510 provides access to a settings or preferences module 530, which allows the user to change a selected download criteria (e.g., via the search module 520), set account information (e.g., for access to the external source 300), enable/disable the media system 100, and/or enable/disable WiFi connectivity. Each setting or preference change can fire a corresponding intent, broadcasted within the media system 100.

The media system 100 may include a service receiver 540 that receives broadcasted intents and calls corresponding services, if any are available. Intents can be fired off at very specific points in time. In the example shown, the service receiver 540 can receive a search change intent broadcasted after a download criteria was set or changed. In particular, selection of a new artist from the search list 244 may cause firing of a search change intent, which is receivable by the service receiver 540.

In some implementations, a media system 500 includes a master list updater 550 and an after call updater 560. The master list updater 550 can be executed when the download criteria changes (e.g., from top tracks to artist top tracks) or when all preview media files 102 in the queue 122 have been played. For example, the service receiver 540 may receive a “criteria change intent,” broadcasted after the download criteria changes, or an “all files played intent,” broadcasted after all preview media files 102 in the queue 122 have been played, and then call the master list updater 550. Upon execution, the master list updater 550 may check a connection status with the Internet and/or the external source 300. If there is no connection to the internet and/or the external source 300, the master list updater 550 returns with no action. Otherwise, in some implementations, the master list updater 550 removes played preview media file(s) 102, if any, from a file system 552 (e.g., memory) of the electronic device 200 and corresponding profiles of the played preview media file(s) 102 form a database 554 of the media system 100. The master list updater 550 may check a page variable delivered with the corresponding intent, to determine whether to fetch new profile data or retrieve the same set of profile data (e.g., if the download criteria did not change) for the preview media file(s) 102. In some examples, the master list updater 550 executes a query on the external source 300, requesting profile data (e.g., returned in an XML, format) of one or more preview media files 102. The master list updater 550 may try executing the query several times (e.g., three times) before returning with no results. If there were no errors, the master list updater 550 may check to make sure there is actually profile data (e.g., track data), as some artists have no associated profile data. For song media, the master list updater 550 may download five tracks sequentially to the file system 552. The master list updater 550 may also download from the external source 300 the corresponding profile data, such as album art, artist name, album name, track name, etc. and store the profile data to the database 554 in the order of retrieval.

The service receiver 540 may call the after call updater 560 for execution upon termination of a communication with the electronic device 200. For example, the electronic device 200 or the media system 100 can broadcast “a communication termination intent” upon receiving of a communication event (e.g., a phone call) and “an idle intent” upon termination of the communication event (e.g., hanging up/ending a phone call), indicating that the electronic device 200 is entering an idle state. The service receiver 540 receives the broadcasted communication termination intent and the idle intent and verifies that the electronic device 200 indeed received and completed a communication event and then calls the after call updater 560.

In some examples, the after call updater 560 sequentially iterates or loops through the database 554 or queried recordset of the database 554 one database record at a time, starting one after a current database record. The after call updater 560 obtains information from the sequentially next database record (e.g., by an index or identifier) and checks to see if a corresponding preview media file 102 exists in the file system 552. If the preview media file 102 exists, the after call updater 560 may set that preview media file 102 as a current communication notifier (e.g., ringtone, email alert, page ringer, etc.) and then exit the loop or iteration. The after call updater 560 may check the current connection status, and if connected, downloads a new preview media file 102 from the external source 300. To download the new preview media file 102, the after call updater 560 can check (query) the database 554 for a record count. If the database 554 contains less than a threshold number (e.g., 5, 7, 10, 20, etc.) of database records corresponding to preview media files 102, the after call updater 560 can download more preview media files 102 and associated profiles until the database 554 contains the threshold number of database records. Moreover, the after call updater 560 may query the database 554 for records corresponding to played preview media files or loop through all of the database records to determine which preview media files 102 have been played and then delete the records corresponding to the played preview media files 102. In some implementations, the after call updater 560 checks for preview media files 102 having no or incomplete records corresponding records in the database 554 and then downloads from the external source 300 and stores the corresponding profile information in the database 554 for any such preview media files 102. The after call updater 560 may check if the number of un-played preview media files 102 is below a threshold number, and if so, downloads and stores from the external source 300 additional preview media files 102 in the file system 552 and/or corresponding profile information in the database 554. The preview media files 102 and/or corresponding profile information can be a random assortment from the external source that meets the download criteria.

Upon completion of a communication event, the media system 100 executes an after call module 570, which can display profile information of the played preview media file 102 as well as a purchase solicitation on the electronic device 200. The profile information may include, but is not limited to, the name of the artist, the name of the song, the name of the album, etc. The user may elect to purchase the whole media file 104 corresponding to the played media file 102 (e.g., by clicking a button or selecting a payment method). In some implementations, the after call module 570 receives the purchase request and executes a purchase order with the external source 300 to purchase and download the whole media file 104. The external source 300 may verify payment and return an authorization code as a receipt and authorization to download the whole media file 104. After receiving the whole media file, the after call module 570 may store the whole media file 104 in the file system 552 and any corresponding profile information in the database 554, for subsequent access by the user. Afterwards, the media system 100 can enter an idle state until activation by any subsequent incoming communication, communication event, or user activation (e.g., button click, etc.).

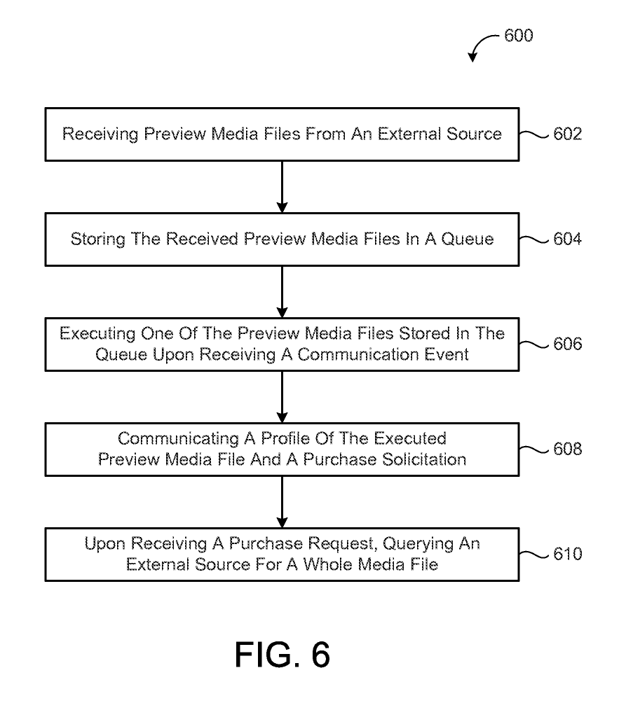

FIG. 6 provides an exemplary arrangement 600 of operations for accessing and executing digital media. The operations include receiving 602 preview media files from an external source, storing 604 the received preview media files in a queue of an electronic device, and executing 606 one of the preview media files stored in the queue upon receiving a communication event. The communication event may include at least one of a phone call, a text message, an email, a video call, and a page. The operations further include electronically communicating 608 a profile of the executed preview media file and a purchase solicitation to a user of the electronic device, and upon receiving a purchase request, querying 610 an external source for a whole media file corresponding to the executed preview media file. In some implementations, the operations include querying the external source to receive preview media files and/or removing the executed preview media file from the queue after executing of the preview media file. The operations may include receiving at least one additional preview media file from the external source and storing the at least one additional received preview media file in the queue after removing the executed preview media file from the queue. Receipt of the preview media files may be limited to a threshold number of preview media files stored in the queue over a time period. Moreover, the operations may include randomly selecting one of the received media preview files from the queue for execution.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method of accessing and executing digital media, the method comprising:
receiving preview media files from an external source;
storing the received preview media files in a queue of an electronic device;
executing one of the preview media files stored in the queue upon receiving a communication event;
electronically communicating a profile of the executed preview media file and a purchase solicitation to a user of the electronic device; and
upon receiving a purchase request, querying the external source for a whole media file corresponding to the executed preview media file.

2. The method of claim 1, further comprising querying the external source to receive preview media files.

3. The method of claim 1, further comprising:
removing the executed preview media file from the queue after executing the preview media file; and
receiving at least one additional preview media file from the external source and storing the at least one additional received preview media file in the queue after removing the executed preview media file from the queue.

4. The method of claim 1, further comprising:
limiting receipt of the preview media files in the queue to a threshold number of preview media files stored in the queue over a time period; and
receiving additional preview media files from the external source when a number of preview media files in the queue is below a threshold queue number.

5. The method of claim 4, further comprising receiving a number of preview media file equal to a difference between the threshold queue number and a number of preview media files in the queue.

6. The method of claim 1, further comprising randomly selecting one of the received media preview files from the queue for execution.

7. The method of claim 1, wherein the communication event comprises at least one of a phone call, a text message, an email, a video call, and a page.

8. A media system comprising:
a file manager receiving preview media files from an external source and storing the received preview media files in a queue of an electronic device;
a player executing one of the preview media files stored in the queue upon receiving a communication event; and
a purchase manager electronically communicating a profile of the executed preview media file and a purchase solicitation to a user of the electronic device;
wherein upon receiving a purchase request, the purchase manager querying the external source for a whole media file corresponding to the executed preview media file.

9. The media system of claim 8, wherein the file manager queries the external source to receive preview media files.

10. The media system of claim 8, wherein the file manager
removes the executed preview media file from the queue after executing the preview media file, and
receives at least one additional preview media file from the external source and stores the at least one additional received preview media file in the queue after removing the executed preview media file from the queue.

11. The media system of claim 8, wherein the file manager
limits receipt of the preview media files in the queue to a threshold number of preview media files stored in the queue over a time period, and
receives additional preview media files from the external source when a number of preview media files in the queue is below a threshold queue number.

12. The media system of claim 11, wherein the file manager receives a number of preview media file equal to a difference between the threshold queue number and a number of preview media files in the queue.

13. The media system of claim 8, wherein the player randomly selects one of the received media preview files from the queue for execution.

14. The media system of claim 8, wherein the communication event comprises at least one of a phone call, a text message, an email, a video call, and a page.

15. A method of accessing and executing digital media, the method comprising:
receiving a download criteria;
broadcasting within an electronic device a change intent corresponding to the download criteria;
in response to the broadcasted change intent, executing a list service on a processor of the electronic device, the list service receiving preview media files from an external source according to the download criteria;
in response to initiation of a communication event, executing a preview media file;
electronically displaying a profile corresponding to the executed preview media file and a purchase solicitation; and
upon receiving a purchase request, receiving a whole media file from the external source corresponding to the executed preview media file.

16. The method of claim 15, further comprising attempting to receive additional preview media files after termination of the communication event.

17. The method of claim 15, further comprising:
receiving the preview media files into a queue;
limiting receipt of the preview media files in the queue to a threshold number of preview media files stored in the queue over a time period;
removing the executed preview media file from the queue after executing the preview media file; and
receiving at least one additional preview media file from the external source and storing the at least one additional received preview media file in the queue after removing the executed preview media file from the queue.

18. The method of claim 17, further comprising randomly selecting one of the received media preview files from the queue for execution.

19. The method of claim 17, further comprising receiving additional preview media files from the external source when a number of preview media files in the queue is below a threshold queue number, receiving a number of preview media file equal to a difference between the threshold queue number and a number of preview media files in the queue.

20. A method comprising:
receiving preview media files;
using one of the preview media files upon receiving a communication event to receive streaming media to an electronic device;
electronically communicating a profile of the used preview media file and a purchase solicitation; and
upon receiving a purchase request, receiving a whole media file corresponding to the executed preview media file, the whole media file providing access to additional streaming media;
wherein the preview media file provides access to corresponding preview streaming media and the whole media file provides access to full length streaming media.

21. The method of claim 20, wherein the preview media file includes at least one of account information, access information, a source address, a destination address, and a media selection criteria.

22. The method of claim 20, further comprising electronically displaying the profile of the used preview media file and the purchase solicitation on the electronic device.

23. The method of claim 20, further comprising:
storing the received preview media files in a queue;
limiting storage of the preview media files in the queue to a threshold number of preview media files over a time period;
removing the used preview media file from the queue after using the preview media file to receive streaming media;
receiving at least one additional preview media file from an external source and storing the at least one additional received preview media file in the queue after removing the used preview media file from the queue.

24. The method of claim 23, further comprising randomly selecting one of the received media preview files from the queue for usage to receive steaming media.

25. The method of claim 23, further comprising receiving additional preview media files from the external source when a number of preview media files in the queue is below a threshold queue number, receiving a number of preview media file equal to a difference between the threshold queue number and a number of preview media files in the queue.
